(19) United States
(12) Patent Application Publication
(10) Pub. No.: US 2015/0356467 A1
(43) Pub. Date: Dec. 10, 2015

(54) METHODS AND DEVICES FOR PROMPTING SEAT SELECTION

(71) Applicant: Xiaomi Inc., Beijing (CN)

(72) Inventors: Mingxue Kangshang, Beijing (CN); Zhilin Nong, Beijing (CN); Zhenyu Sha, Beijing (CN)

(73) Assignee: Xiaomi Inc.

(21) Appl. No.: 14/585,909

(22) Filed: Dec. 30, 2014

Related U.S. Application Data
(63) Continuation of application No. PCT/CN2014/089327, filed on Oct. 23, 2014.

(30) Foreign Application Priority Data
Jun. 6, 2014 (CN) 201410250656.9

(51) Int. Cl. G06Q 10/02

(52) U.S. Cl. CPC G06Q 10/02

(57) ABSTRACT

A method for a device to prompt seat selection is provided. The method includes: receiving a viewing site identification (ID); determining a seat ID associated with the viewing site ID and one or more seat parameters corresponding to the seat ID based on a database; calculating an angle between a line segment and a plane of a viewed area based on the seat parameters, wherein the line segment connects a seat corresponding to the seat ID to a preset position of the viewed area; selecting the seat ID as a target seat ID if the calculated angle is in a preset range; and outputting the target seat ID.

### CROSS-REFERENCE TO RELATED APPLICATIONS

This application is a continuation of International Application No. PCT/CN2014/089327, filed Oct. 23, 2014, which is based upon and claims priority to Chinese Patent Application No. CN201410250656.9, filed Jun. 6, 2014, the entire contents of all of which are incorporated herein by reference.

### TECHNICAL FIELD

The present disclosure generally relates to the field of communication technology and, more particularly, to methods and devices for prompting seat selection.

### BACKGROUND

Conventionally, a seat selection function is provided in ticketing systems for cinemas, theaters and vocal concerts. For example, a user clicks a desired seat in a seat selection interface provided by the ticketing system, and the system reserves the clicked seat for the user.

Although the user can select the desired seat through the ticketing system, the selected seat may not at a good viewing position. For example, due to a viewing angle or a viewing distance, when seating on a certain seat of a cinema, the user may need to turn his/her head left or right for viewing contents close to edges of the movie screen, or need to look up at the screen for a long time, which degrade user viewing experience.

### SUMMARY

According to a first aspect of the present disclosure, there is provided a method for a device to prompt seat selection, comprising: receiving a viewing site identification (ID); determining a seat ID associated with the viewing site ID and one or more seat parameters corresponding to the seat ID based on a database; calculating an angle between a line segment and a plane of a viewed area based on the seat parameters, wherein the line segment connects a seat corresponding to the seat ID to a preset position of the viewed area; selecting the seat ID as a target seat ID if the calculated angle is in a preset range; and outputting the target seat ID.

According to a second aspect of the present disclosure, there is provided a device for prompting seat selection, comprising: a processor; and a memory for storing instructions executable by the processor. The processor is configured to: receive a viewing site identification (ID); determine a seat ID associated with the viewing site ID and one or more seat parameters corresponding to the seat ID based on a database; calculate an angle between a line segment and a plane of a viewed area based on the seat parameters, wherein the line segment connects a seat corresponding to the seat ID to a preset position of the viewed area; select the seat ID as a target seat ID if the calculated angle is in a preset range; and output the target seat ID.

According to a third aspect of the present disclosure, there is provided a non-transitory computer-readable storage medium having stored therein instructions that, when executed by a processor of a device, cause the device to perform a method for prompting seat selection, the method comprising: receiving a viewing site identification (ID); determining a seat ID associated with the viewing site ID and seat parameters corresponding to the seat ID based on a database; calculating an angle between a line segment and a plane of a viewed area based on the seat parameters, wherein the line segment connects a seat corresponding to the seat ID to a preset position of the viewed area; selecting the seat ID as a target seat ID if the calculated angle is in a preset range; and outputting the target seat ID.

It is to be understood that both the foregoing general description and the following detailed description are exemplary rather than limiting the present disclosure.

### BRIEF DESCRIPTION OF THE DRAWINGS

The accompanying drawings, which are incorporated in and constitute a part of the specification, illustrate embodiments in accordance with the present invention and serve to explain principles of the present invention.

FIG. 1 is a flowchart of a method for prompting seat selection, according to an exemplary embodiment.

FIG. 2 shows a longitudinal sectional view of a projection hall of a cinema, according to an exemplary embodiment.

FIG. 3 is a block diagram of a device for prompting seat selection, according to an exemplary embodiment.

FIG. 4 is a block diagram of a terminal device for prompting seat selection, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

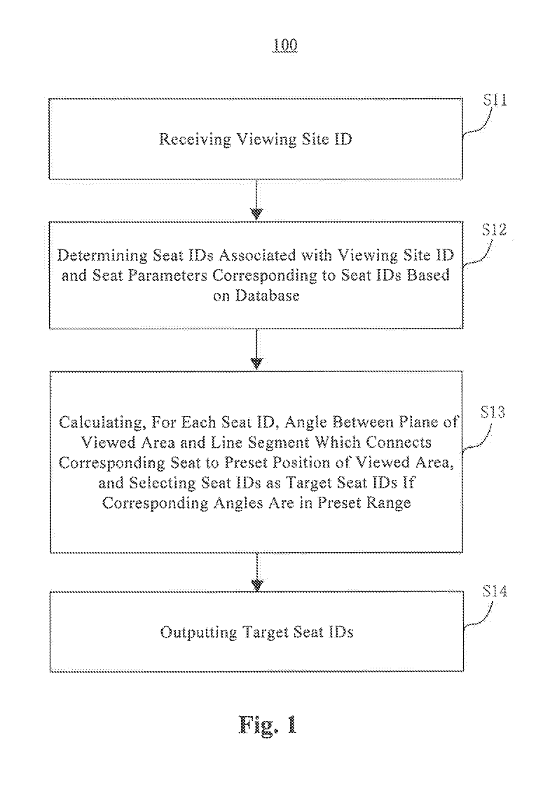

FIG. 1 is a flowchart of a method 100 for prompting seat selection, according to an exemplary embodiment. The method 100 for prompting seat selection may be performed by a terminal device. The method 100 for prompting seat selection may prompt identifications for target seats with desired viewing effect, thereby reducing time taken by a user for seat selection. Referring to FIG. 1, the method 100 includes the following steps.

In step S11, the terminal device receives a viewing site identification.

For example, the viewing site identification (ID) may be inputted by a user. The viewing site ID may be represented by a number, a name or other type of characters associated with the viewing site. For example, the viewing site ID may be “projection hall 11, Beijing Cinema”. In some embodiments, the viewing site may be a cinema, an opera house or a vocal concert site.

In step S12, the terminal device determines seat IDs associated with the viewing site ID and seat parameters corresponding to the seat IDs based on a database.

For example, after receiving the viewing site ID, the terminal device looks up, in the database, seat IDs associated with the viewing site ID and seat parameters corresponding to the seat IDs. In general, each viewing site ID may have a plurality of associated seat IDs, and each seat ID may have one or more corresponding seat parameters.

In exemplary embodiments, a seat ID may include a row number and column number of a seat, such as a seat ID of row 5 & column 3 meaning the 3rd position in the 5th row. The seat parameters may include, e.g., a length and a width of a viewed area (e.g., a movie screen); a distance from the bottom of the viewed area to a ground level; a distance from the seat to the viewed area; a distance the seat above the ground level, a shortest distance between the seat and a top end of the viewed area; a shortest distance between the seat and a left end of the viewed area, and a shortest distance between a segment of the seat and a right end of the viewed area.

In step S13, according to seat parameters corresponding to the respective seat IDs, the terminal device calculates, for each seat ID, an angle between a plane of the viewed area and a line segment which connects the seat corresponding to the seat ID to a preset position of the viewed area, and selects seat IDs as target seat IDs if the corresponding angles are in a preset range.

In exemplary embodiments, the viewed area may be a movie screen, a stage of an opera house, etc. The preset position of the viewed area may be a top end of the viewed area or a left or right end of the viewed area. The line segment between the seat and the preset position of the viewed area may correspond to a sightline of the user when the user views from the seat to the preset position of the viewed area. The terminal device may calculate the angle between the plane of the viewed area and the line segment which connects the seat and each of different positions of the viewed area for different purposes.

In one exemplary embodiment, the terminal device calculates an angle between the plane of the viewed area and a line segment which connects the seat corresponding to a seat ID and the top end of the viewed area, and selects the seat ID as a target seat ID if the angle is in a preset range. In some embodiments, the line segment may be of the shortest length among all line segments from any point of the seat to the top end of the viewed area. In this example, the purpose of calculating the angle is to determine whether the user needs to look up towards the viewed area for a long period of time. For example, if the calculated angle is smaller than 55 degrees, the angle between the line segment (the first line segment) and a second line segment, which connects the seat and the viewed area and is perpendicular to the plane of the viewed area, is greater than 35 degrees. Then the user sitting in the seat corresponding to the seat ID may need to look up towards the viewed area for a long period of time. As another example, if the calculated angle is greater than or equal to 55 degrees, the angle between the first line segment and the second line segment is smaller than 35 degrees. Then the user sitting in the seat corresponding to the seat ID may not need to look up towards the viewed area for a long period of time. In some embodiments, the preset range may be set to from 0 degree to 35 degrees, and the seat ID is selected as a target seat ID if the angle between first line segment and the second line segment is in the range of 0 degree to 35 degrees. When the user selects the seat corresponding to the target seat ID, user viewing experience may be improved.

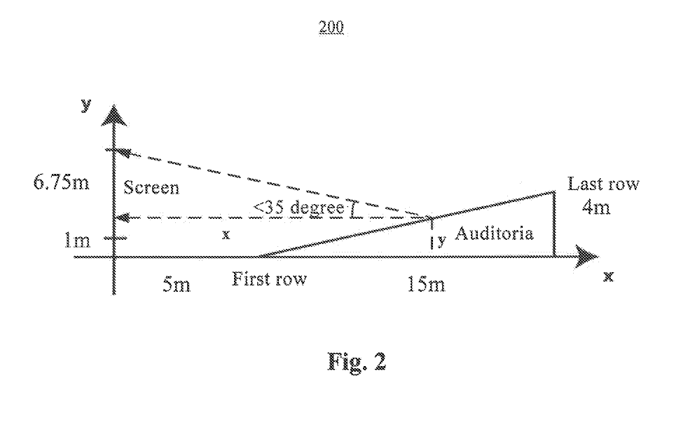

FIG. 2 shows a longitudinal sectional view 200 of a projection hall of a cinema, according to an exemplary embodiment. In this example, the last row of seats is 4 meters higher than the first row in a vertical direction, and there are 16 rows of seats in the projection hall. Assuming the horizontal distance between adjacent rows is 1 meter, then the horizontal distance between the last row and the first row is 15 meters. Accordingly, the seats in the auditoria elevate along a 15 degree angle. It is assumed in this example that a screen with a width of 9 meters and a length of 6.75 meters is provided for the projection hall. The distance from the bottom of screen to the ground is, e.g., 1 meter, and the distance from the screen to the first row is, e.g., 5 meters. Using X to denote the distance from a viewer to the screen, the altitude of the viewer's position to the ground may be calculated as: y=(x−5)*4/15. The condition that the angle between the sightline of the viewer towards the top end of the screen and the horizontal plane is smaller than 35 degrees, can be expressed as:

$$arctan \frac{7.75 - \frac{4}{15} ( x - 5 )}{x} < 35 ° .$$

The solution is that x should be greater than 9.36 meters. In this example, the horizontal distance between the 5th row and the screen is 9 meters, and the horizontal distance between the 6th row and the screen is 10 meters. Thus, only after the 6th row, the angle between the sightline towards the top end of the screen and the horizontal plane will be smaller than 35 degrees. Therefore, to prevent a user from looking up towards the screen for a long period of time, seat IDs corresponding to seats behind the 6th row are outputted to the user for selection.

In one exemplary embodiment, the terminal device may calculate a first angle between the plane of the viewed area, and a first line segment which connects the seat corresponding to a seat ID to the right end of the viewed area. The terminal device may also calculate a second angle between the plane of the viewed area, and a second line segment which connects the seat corresponding to the seat ID to the left end of the viewed area. Then, a sum of the first angle and the second angle is taken as a third angle, and the seat ID is selected as a target seat ID if the third angle is in a preset range. In some embodiments, the first line segment may be of the shortest length among all line segments from any point of the seat to the right end of the viewed area. In some embodiments, the second line segment may be of the shortest length among all line segments from any point of the seat to the left end of the viewed area. The purpose of calculating the third angle is to determine whether a user needs to often turn his/her head left and right to view contents close to edges of the viewed area or whether the user is too close to too far from the viewed area. If the third angle is smaller than, e.g., 140 degrees, then the angle between the first line segment and the second line segment is greater than 40 degrees. Accordingly, the terminal device may determine that the seat corresponding to the seat ID is too close to the viewed area, and the user sitting in the seat corresponding to the seat ID needs to turn his/her head left or right to view the entire viewed area. If the third angle is greater than, e.g., 154 degrees, then the angle between the first line segment and the second line segment is smaller than 26 degrees. Accordingly, the terminal device may determine that the seat of the seat ID is too far from the viewed area, and the user sitting in the seat corresponding to the seat ID may not view the viewed area clearly. If the third angle is greater than 140 degrees and smaller than 154 degrees, the angle between the first line segment and the second line segment is between 26 degrees and 40 degrees. Accordingly, the terminal device may select the seat ID as a target seat ID, because the seat corresponding to the seat ID has a good viewing angle and is in a moderate distance from the viewed area. Accordingly, user viewing experience is improved.

In one exemplary embodiment, based on seat parameters corresponding to respective seat IDs, the terminal device may calculate a first angle between the plane of the viewed area, and a first line segment which connects each of the seats corresponding to the respective seat IDs to the top end of the viewed area. In some embodiments, the first line segment may be of the shortest length among all line segments from any point of the seat to the top end of the viewed area. The terminal device may select ones of the seat IDs as candidate target seat IDs if the corresponding first angles are in a first preset range. Based on seat parameters corresponding to the candidate target seat IDs, for each of the candidate target seat IDs, the terminal device may calculate a second angle between the plane of the viewed area and a second line segment which connects the seat corresponding to the candidate target seat ID to the right end of the viewed area. Based on seat parameters corresponding to the candidate target seat IDs, for each of the candidate target seat IDs, the terminal device may also calculate a third angle between the plane of the viewed area and a third line segment that connects the corresponding seat to the left end of the viewed area. In some embodiments, the second line segment may be of the shortest length among all line segments from any point of the seat to the right end of the viewed area, and the third line segment may be of the shortest length among all line segments from any point of the seat to the left end of the viewed area. The sum of the second angle and the third angle is taken as a fourth angle, and the candidate target seat IDs are selected as target seat IDs if the corresponding fourth angles are in a second preset range.

Referring back to FIG. 1, in step S14, the terminal device may output the target seat IDs.

In some embodiments, the terminal device may output each of the target seat IDs for the user to select at a substantially same time when it is selected at step S13. By using the method 100, the terminal device can provide target seat IDs with desired viewing effect to the user, thereby reduce the time taken by the user to select seats.

In exemplary embodiments, the method 100 may further include the following steps: determining whether a distance between a seat corresponding to a target seat ID and a sound source is smaller than or equal to a threshold; performing step S14 if the distance between the seat corresponding to the target seat ID and the sound source is smaller than or equal to the threshold; and outputting a prompting message indicating that the sound source is too far away if the distance between the seat corresponding to the target seat ID and the sound source is greater than the threshold. For example, the threshold for perceiving sound-image time difference of human being is about −160 milliseconds to +65 milliseconds, that is, sound arriving 0.065 second ahead of image to 0.16 second after image would be acceptable. The propagation velocity of sound in air is about 340 meters per second. Since sound can travel a distance of 54 meters in 0.16 second, the threshold may be set to 54 meters. If the distance between a seat corresponding to a target seat ID and a sound source is less than or equal to 54 meters, nonsynchronous sound and image phenomenon may not occur for the seat corresponding to the target seat ID, and step S14 may be performed to output the target seat ID. If the distance between a seat corresponding to a target seat ID and a sound source is greater than 54 meters, nonsynchronous sound and image phenomenon may occur for the seat corresponding to the target seat ID, and a prompting message indicating that the sound source is too far may be outputted to inform the user that nonsynchronous sound and image phenomenon is likely to occur for the seat corresponding to the target seat ID.

In exemplary embodiments, the method 100 may further include the following steps: determining whether a target seat ID is included in user history data, the user history data including previously selected seats by the user; performing step S14 if the target seat ID is included in the user history data; and outputting a prompting message that the target seat ID is not included in the user history data if the target seat ID is not included in the user history data. For example, a seat ID in the user history data is row 7 & column 8. If the target seat ID is row 7 & column 8, it is likely that the user would prefer the target seat ID, and the target seat ID row 7 & column 8 is outputted. If the target seat ID is row 6 & column 9, it is likely that the user would not prefer the target seat ID, a message such as “the target seat ID row 7 & column 8 is not in user history data” may be outputted to the user. In doing so, seat IDs that have been selected by the user in the past may be outputted for the user to select a preferred seat among the target seat IDs.

In exemplary embodiments, the method 100 may further include the following steps: determining whether a number of occurrences of a target seat ID in user history data is greater than or equal to a threshold; performing step S14 if the number of occurrences of the target seat ID in the user history data is greater than or equal to the threshold; and outputting a prompting message indicating that the number of occurrences of the target seat ID in the user history data is less than the threshold if the number of occurrences of the target seat ID in the user history data is less than the threshold. For example, if the target seat ID is row 7 & column 8, and the seat ID row 7 & column 8 occurs 5 times in user history data, assuming the threshold is 3, since the time of occurrences of seat ID row 7 & column 8 in history data is 5 which is greater than the threshold 3, the user likely would prefer the target seat ID and target seat ID row 7 & column 8 is outputted. If the target seat ID is row 7 & column 8, and the seat ID row 7 & column 8 occurs 2 times in the user history data, assuming the threshold is 5, since the time of occurrences of seat ID row 7 & column 8 in the user history data is 2 which is smaller than the threshold 3, the user likely would not prefer the target seat ID and characters such as “the 2 occurrences of target seat ID row 7 & column 8 in user history data is less than the threshold 3” may be outputted to inform the user. In doing so, seat IDs that have been selected more frequently by the user may be outputted for the user to select his preferred seats among the target seat IDs.

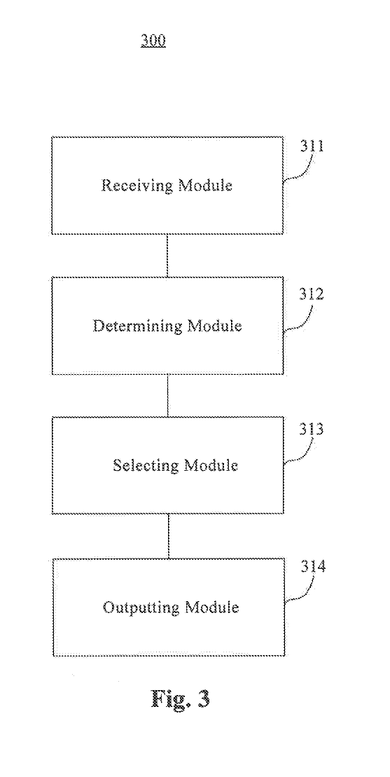

FIG. 3 is a block diagram of a device 300 for prompting seat selection, according to an exemplary embodiment. The device 300 for prompting seat selection can provide target seat IDs with desired viewing effect and thereby reduce the time taken for a user to select seats. Referring to FIG. 3, the device 300 includes a receiving module 311, a determining module 312, a selecting module 313, and an outputting module 314.

The receiving module 311 is configured to receive a viewing site ID.

The determining module 312 is configured to determine seat IDs associated with the viewing site ID and seat parameters corresponding to the seat IDs based on a database.

The selecting module 313 is configured to calculate, according to the seat parameters, an angle between a plane of a viewed area and a line segment which connects each of the seats corresponding to the seat IDs to a preset position of the viewed area, and to select seat IDs as target seat IDs if the corresponding angles are in a preset range.

The outputting module 314 is configured to output the target seat IDs.

In some embodiments, the selecting module 313 may include a first calculating unit and a first selecting unit (not shown). The first calculating unit is configured to calculate an angle between the plane of the viewed area and a first line segment which connects the seat corresponding to a seat ID to the top end of the viewed area. The first selecting unit is configured to select the seat ID as a target seat ID if the angle is in a preset range. In some embodiments, the first line segment may be of the shortest length among all line segments from any point of the corresponding seat to the top end of the viewed area.

In some embodiments, the selecting module 313 may further include a second calculating unit and a second selecting unit (not shown). The second calculating unit is configured to calculate, based on seat parameters corresponding to the seat ID, a first angle between the plane of the viewed area and a first line segment which connects the seat corresponding to the seat ID to the right end of the viewed area. The second calculating unit is configured to calculate a second angle between the plane of the viewed area and a second line segment which connects the seat corresponding to the seat ID to the left end of the viewed area, and to take a sum of the first angle and the second angle as a third angle. The second selecting unit is configured to select the seat ID as a target seat ID if the corresponding third angle is in a preset range.

In some embodiments, the selecting module 313 may further include a third calculating unit, a third selecting unit, and a fourth selecting unit. The third calculating unit is configured to calculate a first angle between the plane of the viewed area and a first line segment which connects the seat corresponding to the seat ID to the top end of the viewed area. The third selecting unit is configured to select the seat ID as a candidate target seat ID if the corresponding first angle is in a first preset range. If the seat ID is selected as a candidate target seat ID, the fourth calculating unit is configured to calculate a second angle between the plane of the viewed area and a second line segment which connects the seat corresponding to the candidate target seat ID to the right end of the viewed area, and to calculate a third angle between the plane of the viewed area and a third line segment which connects the seat corresponding to the candidate target seat ID to the left end of the viewed area, and to calculate a sum of the second angle and the third angle as a fourth angle. The fourth selecting unit is configured to select the candidate target seat ID as a target seat ID if the corresponding fourth angle is in a second preset range.

In some embodiments, the device 300 may further include a first determining module and a first executing module (not shown). The first determining module is configured to determine whether a distance between the seat corresponding to a target seat ID and a sound source is smaller than or equal to a threshold. The first executing module is configured to cause the operation of the outputting module 314 if the distance between the seat corresponding to the target seat ID and the sound source is smaller than or equal to the threshold, and to output a prompting message indicating the sound source is located too far away if the distance between the seat corresponding to the target seat ID and the sound source is greater than the threshold.

In some embodiments, the device 300 may further include a second determining module and a second executing module (not shown). The second determining module is configured to determine whether a target seat ID is included in user history data. The second executing module is configured to cause the operation of the outputting module 314 if the target seat ID is included in the user history data, and to output a prompting message indicating that the target seat ID is not included in the user history data when the target seat ID is not included in the user history data.

In some embodiments, the device 300 may further include a third determining module and a third executing module (not shown). The third determining module is configured to determine whether a number of occurrences of a target seat ID in user history data is greater than or equal to a threshold. The third executing module is configured to cause an operation of the outputting module 314 if the number of occurrences of the target seat ID in the user history data is greater than or equal to the threshold, and to output the prompting message that number of occurrences of the target seat ID in the user history data is less than the threshold if the number of occurrences of the target seat ID in the user history data is less than the threshold.

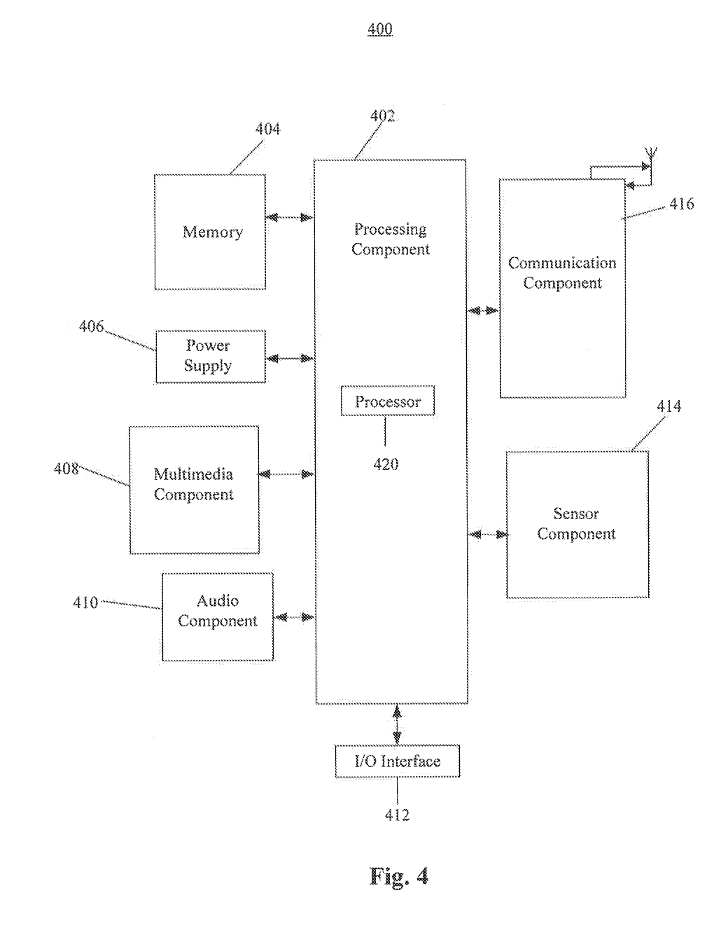

FIG. 4 is a block diagram of a terminal device 400 for prompting seat selection, according to an exemplary embodiment. For example, the terminal device 400 may be a mobile phone, a computer, a digital broadcast terminal, a messaging device, a gaming console, a tablet, a medical device, exercise equipment, a personal digital assistant, and the like.

Referring to FIG. 4, the terminal device 400 may include one or more of the following components: a processing component 402, a memory 404, a power component 406, a multimedia component 408, an audio component 410, an input/output (I/O) interface 412, a sensor component 414, and a communication component 416. The person skilled in the art should appreciate that the structure of the terminal device 400 as shown in FIG. 4 does not intend to limit the terminal device 400. The terminal device 400 may include more or less components or combine some components or other different components.

The processing component 402 typically controls overall operations of the terminal device 400, such as the operations associated with display, telephone calls, data communications, camera operations, and recording operations. The processing component 402 may include one or more processors 420 to execute instructions to perform all or part of the steps in the above described methods. Moreover, the processing component 402 may include one or more modules which facilitate the interaction between the processing component 402 and other components. For instance, the processing component 402 may include a multimedia module to facilitate the interaction between the multimedia component 408 and the processing component 402.

The memory 404 is configured to store various types of data to support the operation of the terminal device 400. Examples of such data include instructions for any applications or methods operated on the terminal device 400, contact data, phonebook data, messages, pictures, video, etc. The memory 404 is also configured to store programs and modules. The processing component 402 performs various functions and data processing by operating programs and modules stored in the memory 404. The memory 404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 406 is configured to provide power to various components of the terminal device 400. The power component 406 may include a power management system, one or more power sources, and any other components associated with the generation, management, and distribution of power in the terminal device 400.

The multimedia component 408 includes a screen providing an output interface between the terminal device 400 and the user. In some embodiments, the screen may include a liquid crystal display (LCD) and/or a touch panel (TP). If the screen includes the touch panel, the screen may be implemented as a touch screen to receive input signals from the user. The touch panel includes one or more touch sensors to sense touches, swipes, and gestures performed on the touch panel. The touch sensors may not only sense a boundary of a touch or swipe action, but also sense a period of time and a pressure associated with the touch or swipe action. In some embodiments, the multimedia component 408 includes a front camera and/or a rear camera. The front camera and the rear camera may receive an external multimedia datum while the terminal device 400 is in an operation mode, such as a photographing mode or a video mode. Each of the front camera and the rear camera may be a fixed optical lens system or have focus and optical zoom capability.

The audio component 410 is configured to output and/or input audio signals. For example, the audio component 410 may include a microphone configured to receive an external audio signal when the terminal device 400 is in an operation mode, such as a call mode, a recording mode, and/or a voice recognition mode. The received audio signal may be further stored in the memory 404 or transmitted via the communication component 416. In some embodiments, the audio component 410 further includes a speaker to output audio signals.

The I/O interface 412 provides an interface between the processing component 402 and peripheral interface modules, such as a keyboard, a click wheel, buttons, and the like. The buttons may include, but are not limited to, a home button, a volume button, a starting button, and/or a locking button.

The sensor component 414 includes one or more sensors to provide status assessments of various aspects of the terminal device 400. For instance, the sensor component 414 may detect an on/off status of the terminal device 400, relative positioning of components, e.g., the display and the keypad, of the terminal device 400, a change in position of the terminal device 400 or a component of the terminal device 400, a presence or absence of user contact with the terminal device 400, an orientation or an acceleration/deceleration of the terminal device 400, and/or a change in temperature of the terminal device 400. The sensor component 414 may include a proximity sensor configured to detect the presence of nearby objects without any contact. The sensor component 414 may also include a light sensor, such as a CMOS or CCD image sensor, for use in imaging applications. In some embodiments, the sensor component 414 may also include an accelerometer sensor, a gyroscope sensor, a magnetic sensor, a pressure sensor, or a temperature sensor.

The communication component 416 is configured to facilitate communication, wired or wirelessly, between the terminal device 400 and other devices. The terminal device 400 can access a wireless network based on a communication standard, such as WiFi, 2G, or 3G, or a combination thereof. In one exemplary embodiment, the communication component 416 receives a broadcast signal or information from an external broadcast management system via a broadcast channel. In one exemplary embodiment, the communication component 416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and/or other technologies.

In exemplary embodiments, the terminal device 400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 404, executable by the processor 420 in the terminal device 400, for performing the above-described methods. For example, the non-transitory computer-readable storage medium may be a ROM, a RAM, a CD-ROM, a magnetic tape, a floppy disc, an optical data storage device, and the like.

The present disclosure may apply to any scenarios that need to select seats for ticketing, such as a cinema, a performance, a vocal concert, a theater and a large scale conference. In addition, the present disclosure can be applied in applications of mobile phones, and be integrated in scenarios in which seats are selected by programs, such as various ticketing systems, PC computer software, and seat selection service provided on webpages.

It should be understood by those skilled in the art that the above described methods, devices, and modules can each be implemented through hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a device to prompt seat selection, comprising:
receiving a viewing site identification (ID);
determining a seat ID associated with the viewing site ID and one or more seat parameters corresponding to the seat ID based on a database;
calculating an angle between a line segment and a plane of a viewed area based on the seat parameters, wherein the line segment connects a seat corresponding to the seat ID to a preset position of the viewed area;
selecting the seat ID as a target seat ID if the calculated angle is in a preset range; and
outputting the target seat ID.

2. The method of claim 1, wherein calculating comprises:
calculating the angle between the line segment and the plane of the viewed area based on the seat parameters, wherein the line segment connects the seat to a top end of the viewed area.

3. The method of claim 1, further comprising:
calculating a first angle between a first line segment and the plane of the viewed area based on the seat parameters, wherein the first line segment connects the seat to a right end of the viewed area;
calculating a second angle between a second line segment and the plane of the viewed area based on the seat parameters, wherein the second line segment connects the seat to a left end of the viewed area; and
selecting the seat ID as the target seat ID if a sum of the first angle and the second angle is in the preset range.

4. The method of claim 1, further comprising:
calculating a first angle between a first line segment and the plane of the viewed area based on the seat parameters, wherein the first line segment connects the seat to a top end of the viewed area;
selecting the seat ID as a candidate target seat ID, if the first angle is in a first preset range;
if the seat ID is selected as a candidate target seat ID, calculating a second angle between a second line segment and the plane of the viewed area based on the seat parameters, wherein the second line segment connects the seat to a right end of the viewed area;
calculating a third angle between a third line segment and the plane of the viewed area, wherein the third line segment connects the seat to a left end of the viewed area; and
selecting the candidate target seat ID as a target seat ID if a sum of the second angle and the third angle is in a second preset range.

5. The method of claim 1, further comprising:
determining whether a distance between the seat and a sound source is smaller than or equal to a threshold;
outputting the target seat ID if the distance between the seat and the sound source is smaller than or equal to the threshold; and
outputting a message indicating that the sound source is too far away if the distance between the seat and the sound source is greater than the threshold.

6. The method of claim 1, further comprising:
determining whether the target seat ID is included in user history data;
outputting the target seat ID if the target seat ID is included in the user history data; and
outputting a message indicating that the target seat ID is not included in the user history data if the target seat ID is not included in the user history data.

7. The method of claim 1, further comprising:
determining whether a number of occurrences of the target seat ID in user history data is greater than or equal to a threshold;
outputting the target seat ID if the number of occurrences of the target seat ID in the user history data is greater than or equal to the threshold; and
outputting a message indicating that the number of occurrences of the target seat ID in the user history data is less than the threshold if the number of occurrences of the target seat ID in the user history data is less than the threshold.

8. A device for prompting seat selection, comprising:
a processor; and
a memory for storing instructions executable by the processor;
wherein the processor is configured to:
receive a viewing site identification (ID);
determine a seat ID associated with the viewing site ID and one or more seat parameters corresponding to the seat ID based on a database;
calculate an angle between a line segment and a plane of a viewed area based on the seat parameters, wherein the line segment connects a seat corresponding to the seat ID to a preset position of the viewed area;
select the seat ID as a target seat ID if the calculated angle is in a preset range; and
output the target seat ID.

9. The device of claim 8, wherein the processor is further configured to:
calculate the angle between the line segment and the plane of the viewed area based on the seat parameters, wherein line segment connects the seat to a top end of the viewed area.

10. The device of claim 8, wherein the processor is further configured to:
calculate a first angle between a first line segment and the plane of the viewed area based on the seat parameters, wherein the first line segment connects the seat to a right end of the viewed area;
calculate a second angle between a second line segment and the plane of the viewed area based on the seat parameters, wherein the second line segment connects the seat to a left end of the viewed area; and
select the seat ID as the target seat ID if a sum of the first angle and the second angle is in the preset range.

11. The device of claim 8, wherein the processor is further configured to:
calculate a first angle between a first line segment and the plane of the viewed area based on the seat parameters, wherein the first line segment connects the seat to a top end of the viewed area;
select the seat ID as a candidate target seat ID if the first angle is in a first preset range;
if the seat ID is selected as a candidate target seat ID, calculate a second angle between a second line segment and the plane of the viewed area, wherein the second line segment connects the seat to a right end of the viewed area;
calculate a third angle between a third line segment and the plane of the viewed area, wherein the third line segment connects the seat to a left end of the viewed area; and
select the candidate target seat ID as the target seat ID if a sum of the second angle and third angle is in a second preset range.

12. The device of claim 8, wherein the processor is further configured to:
determine whether a distance between the seat and a sound source is smaller than or equal to a threshold;
output the target seat ID if the distance between the seat and the sound source is smaller than or equal to the threshold; and
output a message indicating that the sound source is too far away if the distance between the seat and the sound source is greater than the threshold.

13. The device of claim 8, wherein the processor is further configured to:
determine whether the target seat ID is included in user history data;
output the target seat ID if the target seat ID is included in the user history data; and
output a message indicating that the target seat ID is not included in the user history data if the target seat 1D is not included in the user history data.

14. The device of claim 8, wherein the processor is further configured to:
determine whether a number of occurrences of the target seat ID in user history data is greater than or equal to a threshold;
output the target seat ID if the number of occurrences of the target seat ID in the user history data is greater than or equal to the threshold; and
output a message indicating that the number of occurrences of the target seat ID in the user history data is less than the threshold if the number of occurrences of the target seat ID in the user history data is less than the threshold.

15. A non-transitory computer-readable medium having stored therein instructions that, when executed by a processor of a device, cause the device to perform a method for prompting seat selection, the method comprising:
receiving a viewing site identification (ID);
determining a seat ID associated with the viewing site ID and seat parameters corresponding to the seat ID based on a database;
calculating an angle between a line segment and a plane of a viewed area based on the seat parameters, wherein the line segment connects a seat corresponding to the seat ID to a preset position of the viewed area;
selecting the seat ID as a target seat ID if the calculated angle is in a preset range; and
outputting the target seat ID.

16. The non-transitory computer-readable medium of claim 15, wherein the calculating comprises:
calculating the angle between the line segment and the plane of the viewed area based on the seat parameters, wherein the line segment connects the seat to a top end of the viewed area.

17. The non-transitory computer-readable medium of claim 15, wherein the method further comprises:
calculating a first angle between a first line segment and the plane of the viewed area based on the seat parameters, wherein the first line segment connects the seat to a right end of the viewed area;
calculating a second angle between a second line segment and the plane of the viewed area based on the seat parameters, wherein the second line segment connects the seat to a left end of the viewed area; and
selecting the seat ID as the target seat ID if a sum of the first angle and the second angle is in the preset range.

18. The non-transitory computer-readable medium of claim 15, wherein the method further comprises:
calculating a first angle between a first line segment and the plane of the viewed area based on the seat parameters, wherein the first line segment connects the seat to a top end of the viewed area;
selecting the seat ID as a candidate target seat ID if the first angle is in a first preset range;
if the seat ID is selected as a candidate target seat ID, calculating a second angle between a second line segment and the plane of the viewed area, wherein the second line segment connects the seat to a right end of the viewed area;
calculating a third angle between a third line segment and the plane of the viewed area, wherein the third line segment connects the seat to a left end of the viewed area; and
selecting the candidate target seat ID as the target seat ID if a sum of the second angle and the third angle is in a second preset range.

19. The non-transitory computer-readable medium of claim 15, wherein the method further comprises:
determining whether a distance between the seat and a sound source is smaller than or equal to a threshold;
outputting the target seat ID if the distance between the seat and the sound source is smaller than or equal to the threshold; and
outputting a message indicating that the sound source is too far away if the distance between the seat and the sound source is greater than the threshold.

20. The non-transitory computer-readable medium of claim 15, wherein the method further comprises:
determining whether a number of occurrences of the target seat ID in user history data is greater than or equal to a threshold;
outputting the target seat ID if the number of occurrences of the target seat ID in the user history data is greater than or equal to the threshold; and
outputting a message indicating that the number of occurrences of the target seat ID in the user history data is less than the threshold if the number of occurrences of the target seat ID in the user history data is less than the threshold.
